(19) United States
(12) Patent Application Publication
(10) Pub. No.: US 2016/0367920 A1
(43) Pub. Date: Dec. 22, 2016

(54) WATER PURIFIER

(71) Applicant: New Century Membrane Technology Co., Ltd., Taichung (TW)

(72) Inventor: CHI-CHANG KUO, TAICHUNG CITY (TW)

(21) Appl. No.: 14/741,013

(22) Filed: Jun. 16, 2015

(51) Int. Cl. B01D 35/26; B01D 29/56; C02F 1/00

(52) U.S. Cl. CPC B01D 35/26; C02F 1/001; B01D 29/56

(57) ABSTRACT

A water purifier contains: a tank, a pre-filtration unit, a membrane filtration unit, a cover, and a manual pumping unit. The tank includes a storage chamber defined by an external fence and includes an opening and a water inlet. The pre-filtration unit includes at least one box and a filtering material, each box has a separation mesh and plural through holes. The membrane filtration unit is mounted in the storage chamber and includes a water collecting pipe on which plural filtering bags are fitted, each filtering bag has a flow channel communicating with the water collecting pipe. The cover is connected with the tank and includes a body and an outlet connector. The manual pumping unit is connected with the water inlet and includes a water supply groove, a first orifice, a second orifice, and a second hose communicating with the first orifice and connecting with a water supply source.

### BACKGROUND OF THE INVENTION

1. Technical Field

The present invention relates to a water purifier which is operated easily without any power supply.

2. Description of Related Art

A conventional water purifier is disclosed in U.S. Pat. No. 8,105,486 and contains a base, a fixing sleeve disposed on the base and having a first orifice, a water collecting pipe inserted into the first orifice, a filtration unit, a pressing case, a pre-filtration unit above the filtration unit, an air exhaustion unit, and a cover. The filtration unit has a plurality of filtering bags fitted on the water collecting pipe tightly. The pressing case is fitted on the fixing sleeve and has a flexible fringe surrounding around a second orifice, such that when the flexible fringe expands, the first orifice and the second orifice define a water storage space for accommodating waters. The air exhaustion unit is a multi-section telescopic tube and is connected between the water collecting pipe and the cover to discharge airs out of the water purifier.

Thereby, after pressing the cover to drive the flexible fringe of the pressing cover to retract downwardly, the waters in the water storage space are pressed so that the waters are filtered by the pre-filtration unit and the plurality of filtering bags, thus obtaining clean waters.

Although the water purifier is operated without a power supply, it still has disadvantages as follows:

1. The water purifier filters and purifiers the waters based on a water level in the water storage space, so raw waters are manually fed into the water storage space, thus causing troublesome water supplement.

2. The airs in the water collecting pipe and the plurality of filtering bags are discharged out of the water purifier by ways of an air exhaustion unit, thus having complicated structure. Furthermore, the air exhaustion unit is the multi-section telescopic tube which has an upper segment with a small diameter and a lower segment with a large diameter, so its structure is fragile. The pressing case is a bellows, its swings as being pressed unevenly, and then the multi-section telescopic tube is actuated by the pressing case to cause oblique and water leakage.

3. The water purifier contains a water channel system, an upper portion of which is adapted to feed the raw waters, and a lower portion of which is employed to discharge the waters filtered. However, before using the water purifier, the airs in the water storage space are exhausted to have inconvenient operation. Moreover, after the waters are filtered and purified, they spray out of an air outlet on a top end of the multi-section telescopic tube.

The present invention has arisen to mitigate and/or obviate the afore-described disadvantages.

### SUMMARY OF THE INVENTION

The primary objective of the present invention is to provide a water purifier which is operated easily without any power supply.

Another objective of the present invention is to provide a water purifier which filters and purifies waters efficiently.

To obtain the above objectives, a water purifier provided by the present invention contains: a tank, a pre-filtration unit, a membrane filtration unit, a cover, and a manual pumping unit.

The tank includes a storage chamber defined by an external fence, an opening defined on a top end of the external fence and communicating with the storage chamber, and a water inlet formed on the external fence adjacent to a bottom end of the external fence.

The pre-filtration unit is disposed in the storage chamber and corresponds to the water inlet, and the pre-filtration unit includes at least one box stacked in the storage chamber and a filtering material accommodated in each of the at least one box, wherein each box has a separation mesh fixed on a top end thereof and has a plurality of through holes arranged on the separation mesh, and the at least one box is in communication with the storage chamber via the plurality of through holes on each separation mesh.

The membrane filtration unit is mounted in the storage chamber and is located above the pre-filtration unit, and the membrane filtration unit includes a water collecting pipe, a bottom end of which is closed. The membrane filtration unit also includes plural filtering bags fitted on the water collecting pipe and being perpendicular to a central axis of the water collecting pipe, and wherein each filtering bag has a flow channel defined therein and communicating with the water collecting pipe, such that waters are filtered by each filtering bag and are pumped into the water collecting pipe.

The cover is connected with a top end of the tank to close the opening, and the cover includes a body connecting with the external fence and an outlet connector inserted into the body, wherein a first end of the outlet connector is in connection with a top end of the water collecting pipe, and a second end of the outlet connector extends out of the body.

The manual pumping unit is connected with the water inlet of the tank, and the manual pumping unit includes a water supply groove defined by a flexible fringe, a first orifice and a second orifice which extend into the water supply groove from the two ends of the flexible fringe, and a second hose communicating with the first orifice and connecting with a water supply source, wherein the flexible fringe retracts and expands to change a storage volume in the water supply groove, such that the waters are pumped into the water supply groove from the first orifice, and when the flexible fringe is retracted, the waters in the water supply groove are pumped into the at least one body via the second orifice, and the waters are filtered by the membrane filtration unit to flow out of the outlet connector cleanly.

Thereby, the water purifier of the present invention has advantages as follows:

1. The waters are pumped into the water supply groove by operating the manual pumping unit easily and quickly.

2. Air in the storage chamber, the water collecting pipe, and the plural filtering bags discharges out of the tank easily (since the air is more lighter than the waters), so the conventional air exhaustion unit is not configured in the water purifier of the present invention, thus decreasing production cost of the water purifier.

3. Since the conventional air exhaustion unit is not configured in the water purifier of the present invention, and the manual pumping unit is arranged outside the tank, when the flexible fringe of the manual pumping unit swings, it does not influence a tightness of the tank, thus avoiding a water leakage from the tank.

### BRIEF DESCRIPTION OF THE DRAWINGS

FIG. 1 is a cross sectional view showing the assembly of a water purifier according to a first embodiment of the present invention.

FIG. 2 is a perspective view showing the assembly of the water purifier according to the first embodiment of the present invention.

FIG. 3 is a perspective view showing the operation of a manual pumping unit of the water purifier according to the first embodiment of the present invention.

FIG. 4 is a side plan view showing the operation of the water purifier according to the first embodiment of the present invention.

FIG. 5 is another side plan view showing the operation of the water purifier according to the first embodiment of the present invention.

FIG. 6 is a cross sectional view showing the assembly of a water purifier according to a second embodiment of the present invention.

### DETAILED DESCRIPTION OF THE PREFERRED EMBODIMENTS

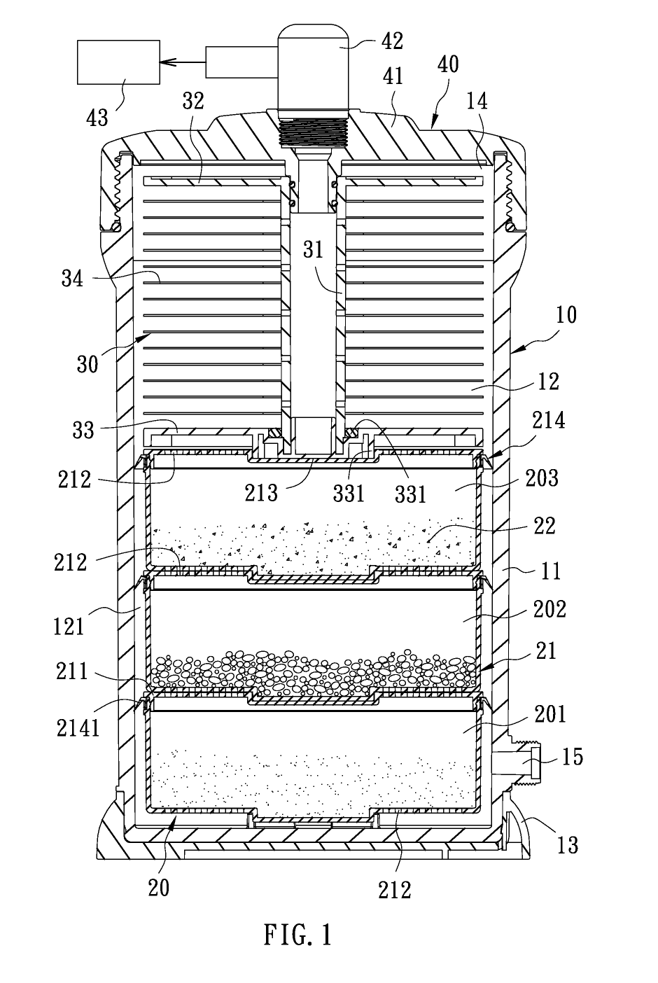

With reference to FIG. 1, a water purifier according to a first embodiment of the present invention comprises: a tank 10, a pre-filtration unit 20, a membrane filtration unit 30, a cover 40, and a manual pumping unit 50.

The tank 10 includes a storage chamber 12 defined by an external fence 11, a connecting holder 13 retained on a bottom end of the external fence 11, an opening 14 defined on a top end of the external fence 11 and communicating with the storage chamber 12, and a water inlet 15 formed on the external fence 11 adjacent to the bottom end of the external fence 11 and above the connecting holder 13.

The pre-filtration unit 20 is disposed in the storage chamber 12 and corresponds to the water inlet 15, and the pre-filtration unit 20 includes at least one box 21 stacked in the storage chamber 12 and includes a filtering material 22 accommodated in each of the at least one box 21, wherein each box 21 has a separation mesh 211 fixed on a top end thereof and has a plurality of through holes 212 arranged on the separation mesh 211. In this embodiment, three boxes 21 are stacked in the storage chamber 12, such that three separation meshes 211 are fixed on tops end of the three boxes 21 to form three accommodating rooms 201, 202, 203 in the three boxes 21, wherein the separation mesh 211 of each box 21 has a retaining portion 213 being a recess and defined on a top surface thereof, and three different filtering materials 22 are placed into the three accommodating rooms 201, 202, 203 of the three boxes 21, the three different filtering materials 22 are any one of carborundum, porphyries andesite, ion exchange resins, and activated carbon, and the three accommodating rooms 201, 202, 203 of the three boxes 21 are in communication with one another via the plurality of through holes 212 on each separation mesh 211, hence waters are pumped into the three boxes 21 from the water inlet 15 and are filtered by the different three filtering materials 22 to eliminate impurities and suspensions in the waters, thus absorbing peculiar smell, chlorine, organic bacteria, and viruses in the waters.

To fix the pre-filtration unit 20 in the storage chamber 12, an outer diameter of each box 21 is less than an inner diameter of the external fence 11. To stop the waters from flowing upwardly, each box 21 has a peripheral closing collar 214 fitted on an outer wall thereof and corresponding to each separation mesh 211, wherein the peripheral closing collar 214 has a stop rib 2141 formed in an inverted L shape, and a distal end of the stop rib 2141 abuts against an inner surface of the external fence 11, thus stopping the waters.

The membrane filtration unit 30 is mounted in the storage chamber 12 and is located above the pre-filtration unit 20, and the membrane filtration unit 30 includes a water collecting pipe 31, an upper limiting disc 32 fitted with a top end of the water collecting pipe 31, a lower limiting disc 33 for closing a bottom end of the water collecting pipe 31 by ways of a waterproof ring 311, and plural filtering bags 34 fixed between the upper limiting disc 32 and the lower limiting disc 33, wherein the plural filtering bags 34 are equidistantly fitted on the water collecting pipe 31 by using a water guiding assembly and are perpendicular to a central axis of the water collecting pipe 31, and wherein each filtering bag 34 has a flow channel defined therein and communicating with the water collecting pipe 31, such that the waters are filtered by each filtering bag 34 and are pumped into the water collecting pipe 31. In addition, the lower limiting disc 33 is proximate to a separation mesh 211 of an uppermost one of the three boxes 21 and has a fixing portion 331 being a protrusion and extending downwardly from a bottom end thereof to retain with the retaining portion 213 of the separation mesh 211 of the uppermost one of the three boxes 21, such that the membrane filtration unit 30 is mounted on the uppermost one of the three boxes 21, and a bottom surface of the lower limiting disc 33 does not completely close a top surface of the uppermost one of the three boxes 21. In this embodiment, an outer diameter of the lower limiting disc 33 is less than the inner diameter of the external fence 11, such that between an outer rim of the lower limiting disc 33 and the inner surface of the external fence 11 is defined a water gap 121.

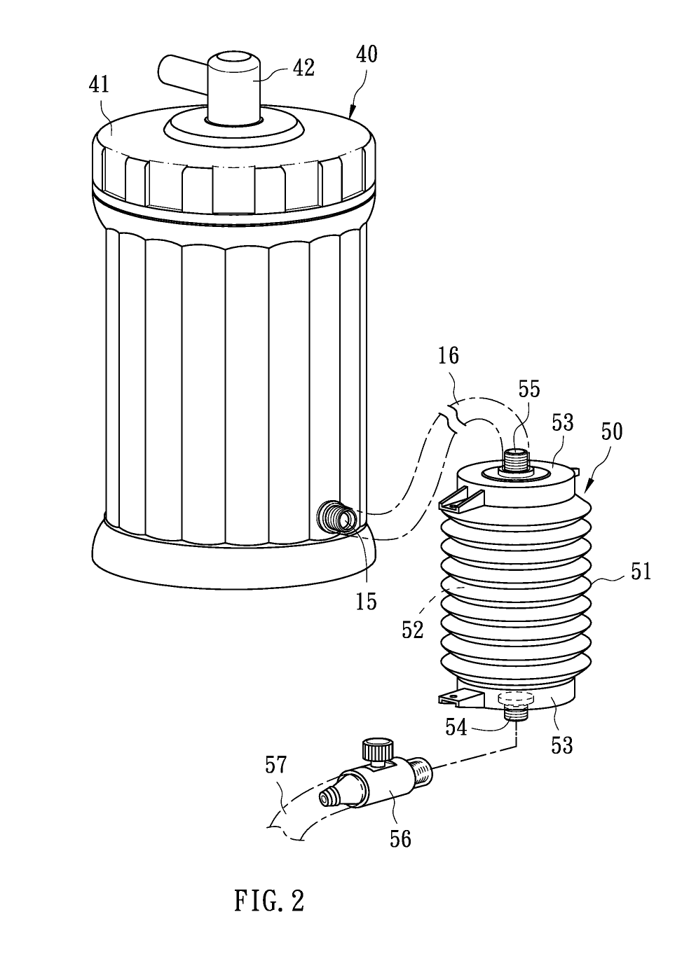

Referring to FIG. 2, the cover 40 is screwed with the top end of the tank 10 to close the opening 14, and the cover 40 includes a body 41 connecting with the external fence 11, an outlet connector 42 inserted into the body 41, and a first check valve 43 secured on the outlet connector 42, wherein a first end of the outlet connector 42 is in connection with the top end of the water collecting pipe 31, and a second end of the outlet connector 42 extends out of the body 41, hence the waters are guided to flow out of the water collecting pipe 31, and the first check valve 43 stops the water from flowing back to the storage chamber 12.

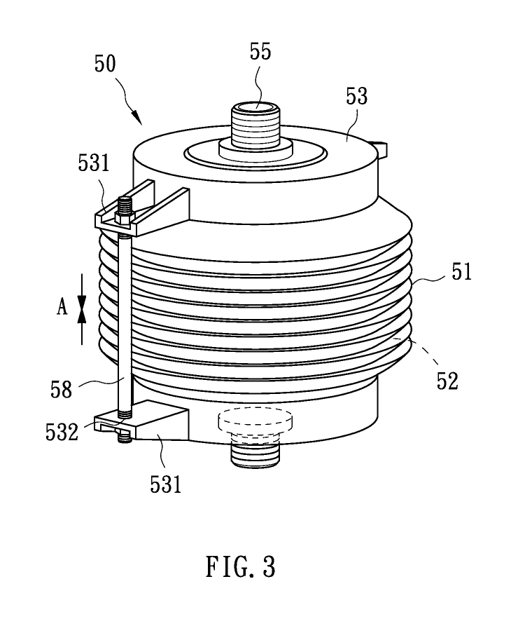

As shown in FIGS. 2 and 3, the manual pumping unit 50 is connected with the water inlet 15 of the tank 10 (via a first hose 16 as illustrated in FIG. 2), and the manual pumping unit 50 includes a water supply groove 52 defined by a flexible fringe 51 to feed the waters into the tank 10, two operating caps 53 fitted on two ends of the flexible fringe 51, a first orifice 54 and a second orifice 55 which extend into the water supply groove 52 from the two ends of the flexible fringe 51, a second check valve 56 joined with the first orifice 54, and a second hose 57 communicating with the first orifice 54 and connecting with a water supply source. Each operating cap 53 has a coupling set 531 arranged thereon. The flexible fringe 51 retracts (as shown in FIG. 3) and expands (as illustrated in FIG. 2) to change a storage volume in the water supply groove 52. In this embodiment, the flexible fringe 51 of the manual pumping unit 50 is any one of a telescopic cylinder, an air pump, and a hand pump.

It is to be noted that the manual pumping unit 50 is removed from the tank 10 when it is not used, as illustrated in FIG. 3, and then the flexible fringe 51 is retracted (denoted by an arrow A of FIG. 3), such that the two operating caps 53 move close to each other, and two locking elements 58 lock with four apertures 532 on two coupling sets 531 of the two operating caps 53, thus retracting the manual pumping unit 50 compactly.

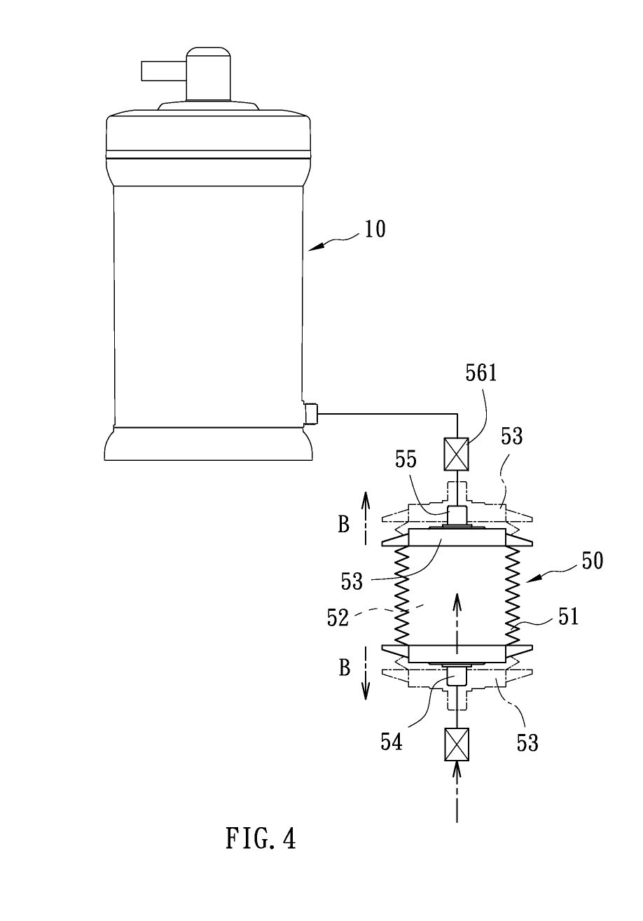

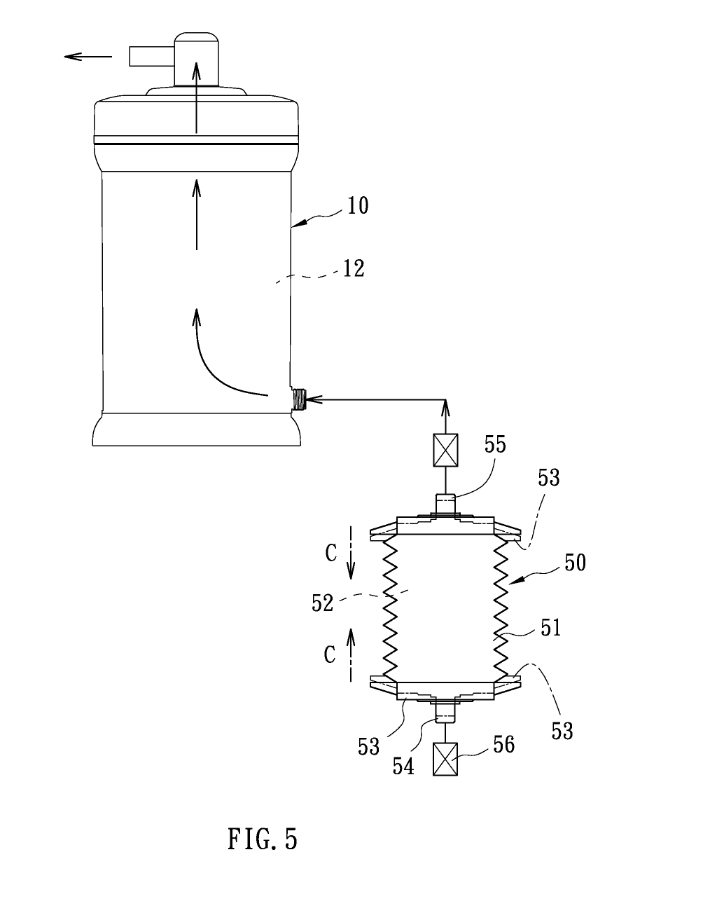

In operation, the two locking elements 58 are removed from the manual pumping unit 50, and the two operating caps 53 are pulled outwardly (indicated by an arrow B of FIG. 4) to expand the flexible fringe 51 (in the meantime, a third check valve 561 on the second orifice 55 is closed), hence the storage volume in the water supply groove 52 of the flexible fringe 51 increases to produce a vacuum suction by which the waters are pumped into the water supply groove 52 from the first orifice 54. With reference to FIGS. 1 and 5, after the water supply groove 52 is full of the waters, the two operating caps 53 are pushed close to each other (designated by an arrow C of FIG. 5) so that the flexible fringe 51 is retracted (in the meantime, the second check valve 56 is closed), and the operating caps 53 push the waters in the water supply groove 52 to flow into the storage chamber 12 of the tank 10 via the second orifice 55, thereafter the waters are pumped into the three boxes 21 from the plurality of through holes 212 on each separation mesh 211 to be filtered by the filtering material 22 of each box 21, and the membrane filtration unit 30 filters the waters to flow clean waters out of the outlet connector 42.

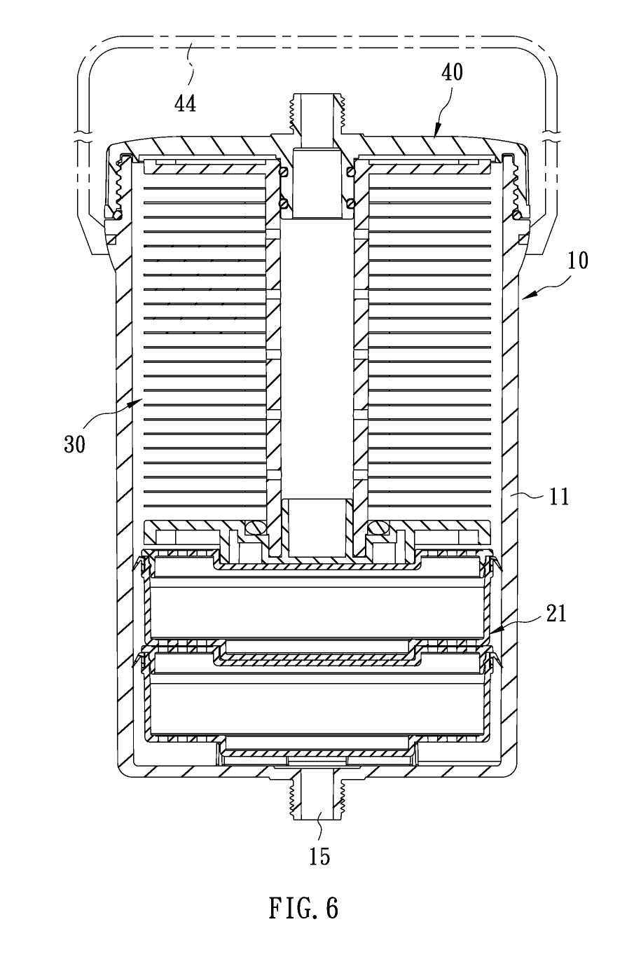

Referring to FIG. 6, a difference of a water purifier of a second embodiment from that of the first embodiment comprises: a water inlet 15 of a tank 10 formed on a bottom end of an external fence 11, and two boxes 21 stacked in the storage chamber 12, such that a manual pumping unit 50 is directly screwed with the water inlet 15 of the tank 10. Furthermore, a cover 40 includes a grip bar 44 rotatably connected therewith so that a user moves or carries the water purifier by holding the grip bar 44.

Thereby, the water purifier of the present invention has advantages as follows:

1. The waters are pumped into the water supply groove 52 by operating the manual pumping unit 50 easily and quickly.

2. Air in the storage chamber 12, the water collecting pipe 31, and the plural filtering bags 34 discharges out of the tank 10 easily (since the air is more lighter than the waters), so the conventional air exhaustion unit is not configured in the water purifier of the present invention, thus decreasing production cost of the water purifier.

3. Since the conventional air exhaustion unit is not configured in the water purifier of the present invention, and the manual pumping unit 50 is arranged outside the tank 10, when the flexible fringe 51 of the manual pumping unit 50 swings, it does not influence a tightness of the tank 10, thus avoiding a water leakage from the tank 10.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A water purifier comprising:
a tank including a storage chamber defined by an external fence, an opening defined on a top end of the external fence and communicating with the storage chamber, and a water inlet formed on the external fence adjacent to a bottom end of the external fence;
a pre-filtration unit disposed in the storage chamber and corresponding to the water inlet, and the pre-filtration unit including at least one box stacked in the storage chamber and a filtering material accommodated in each of the at least one box, wherein each box has a separation mesh fixed on a top end thereof and has a plurality of through holes arranged on the separation mesh, and the at least one box is in communication with the storage chamber via the plurality of through holes on each separation mesh;
a membrane filtration unit mounted in the storage chamber and located above the pre-filtration unit, and the membrane filtration unit including a water collecting pipe, a bottom end of which is closed, the membrane filtration unit also including plural filtering bags fitted on the water collecting pipe and being perpendicular to a central axis of the water collecting pipe, and wherein each filtering bag has a flow channel defined therein and communicating with the water collecting pipe, such that waters are filtered by each filtering bag and are pumped into the water collecting pipe;
a cover connected with a top end of the tank to close the opening, and the cover including a body connecting with the external fence and an outlet connector inserted into the body, wherein a first end of the outlet connector is in connection with a top end of the water collecting pipe, and a second end of the outlet connector extends out of the body;
a manual pumping unit connected with the water inlet of the tank, and the manual pumping unit including a water supply groove defined by a flexible fringe, a first orifice and a second orifice which extend into the water supply groove from two ends of the flexible fringe, and a second hose communicating with the first orifice and connecting with a water supply source, wherein the flexible fringe retracts and expands to change a storage volume in the water supply groove, such that the waters are pumped into the water supply groove from the first orifice, and when the flexible fringe is retracted, the waters in the water supply groove are pumped into the at least one body via the second orifice, and the waters are filtered by the membrane filtration unit to flow out of the outlet connector cleanly.

2. The water purifier as claimed in claim 1, wherein the tank further includes a connecting holder retained on the bottom end of the external fence.

3. The water purifier as claimed in claim 1, wherein the membrane filtration unit further includes an upper limiting disc fitted with the top end of the water collecting pipe and includes a lower limiting disc for closing the bottom end of the water collecting pipe, and the lower limiting disc is proximate to the at least one box, between an outer rim of the lower limiting disc and an inner surface of the external fence is defined a water gap.

4. The water purifier as claimed in claim 3, wherein the lower limiting disc has a fixing portion extending downwardly from a bottom end thereof, and the separation mesh of each box has a retaining portion defined on a top surface thereof to retain with the fixing portion, such that the membrane filtration unit is mounted on the at least one box.

5. The water purifier as claimed in claim 4, wherein the fixing portion of the lower limiting disc is a protrusion, and the retaining portion of each box is a recess.

6. The water purifier as claimed in claim 1, wherein each box of the pre-filtration unit has a peripheral closing collar fitted on an outer wall thereof, and the peripheral closing collar has a stop rib formed in an inverted L shape, and a distal end of the stop rib abuts against an inner surface of the external fence.

7. The water purifier as claimed in claim 1, wherein the manual pumping unit further includes two operating caps fitted on the two ends of the flexible fringe, and each operating cap has a coupling set arranged thereon.

8. The water purifier as claimed in claim 1, wherein the cover further a first check valve secured on the outlet connector to stop the water from flowing back to the storage chamber.

9. The water purifier as claimed in claim 1, wherein the manual pumping unit further includes a second check valve joined with the first orifice.

10. The water purifier as claimed in claim 1, wherein the pre-filtration unit further includes three boxes to accommodate three different filtering materials.

11. The water purifier as claimed in claim 1, wherein the flexible fringe of the manual pumping unit is any one of a telescopic cylinder, an air pump, and a hand pump.
